(19) United States
(12) Patent Application Publication
(10) Pub. No.: US 2018/0184349 A1
(43) Pub. Date: Jun. 28, 2018

(54) A HYBRID WIRELESS COMMUNICATION SYSTEM AND METHOD

(71) Applicant: WIZEDSP LTD., TEL-AVIV (IL)

(72) Inventors: OZ GABAI, TEL-AVIV (IL); NIMROD SANDLERMAN, RAMAT-GAN (IL)

(21) Appl. No.: 15/579,232

(22) PCT Filed: Jun. 5, 2016
(86) PCT No.: PCT/IB16/53293

§ 371 Date: Dec. 4, 2017

Related U.S. Application Data
(60) Provisional application No. 62/171,258, filed on Jun. 5, 2015.

(51) Int. Cl. H04W 36/30; H04W 24/08; H04W 36/32

(52) U.S. Cl. CPC H04W 36/30; H04W 36/32; H04W 24/08

(57) ABSTRACT

A system and a method for selecting wireless communication mode between a mobile device and a local node, where the selection is between RF communication technology and acoustic communication technology, the selection including determining the location of the mobile device with respect to the local node, and selecting the communication mode according to characterization of the location, where the location is characterized according to history of quality of acoustic communication in or around the location.

### CROSS-REFERENCE TO RELATED APPLICATIONS

This application claims the benefit of U.S. Provisional Application No. 62/171,258, filed Jun. 5, 2015, the disclosure of which is incorporated herein by reference in its entirety.

### FIELD

The method and apparatus disclosed herein are related to the field of wireless communication, and, more particularly but not exclusively, to the combination of RF and acoustic wireless communication.

### BACKGROUND

Wi-Fi-enabled mobile phones are known. Mobile devices such as smartphones are commonly operative to provide Internet access via suitable cellular modems. When such device enters a Wi-Fi coverage area, whether at home or in a public place, the device may switches off its cellular Internet access, and use the local Wi-Fi network for Internet access. This reduces the radiation and battery consumption for the mobile device, as well as the load on the cellular network. In some cases, such as roaming, the use of the Wi-Fi network may also reduce cost to the user.

Wi-Fi calling technology is also known. In a Wi-Fi coverage area, a Wi-Fi enabled mobile phone can switches to the local Wi-Fi network to have an Internet access. Phone calls can then be carried to and from the said mobile phone via the Internet, employing, for example, VoIP protocol. An outgoing call, for example, may be carried from the mobile phone to the Internet via the local Wi-Fi network. The call is then received by a suitable Wi-Fi calling service, which is operative to carry the call via the Internet to the target phone. This service reduces the radiation for the mobile phone user and also relieves the traffic load for the cellular carrier as it transfers calls from the cellular network to the Internet when coverage conditions allow.

Acoustic communication may be used as a wireless local area network (WLAN) technology replacing radio-frequency (RF) technologies such as Wi-Fi and Bluetooth. A smartphone's microphone may record the user while the smartphone speaker transmits the user's speech in supersonic frequency range (typically 14-20 kHz) to the local router, and vice-versa. Acoustic communication is even more energy efficient than any RF WLAN technology.

However, acoustic communication is location-sensitive and does not penetrate walls. Therefore, the acoustic communication channel may lost without warning. There is thus a widely recognized need for, and it would be highly advantageous to have, a communication system and method that overcomes the above limitations.

### SUMMARY

According to one exemplary embodiment, there is provided a method, a device, and a computer program for selecting wireless communication mode between a mobile device and a local node, where the selection is between RF communication technology and acoustic communication technology, by measuring the quality of the acoustic communication, and switching to RF communication if the quality of acoustic communication is below a predefined threshold, where the quality of acoustic communication is determined according to measurement of at least one of: signal level, noise level, SNR, BER, QoS, latency, jitter, and frame loss.

Additionally, according to another exemplary embodiment, the method, device, and/or computer program may also include determining the location of the mobile device with respect to the local node, and selecting the communication mode according to characterization of the location, where the location is characterized according to history of quality of acoustic communication in or around the location.

According to another exemplary embodiment, the quality of acoustic communication is measured at least one of continuously and repeatedly.

According to yet another exemplary embodiment, the quality of acoustic communication is measured when the selected communication mode is at least one of RF communication technology and acoustic communication technology.

According to still another exemplary embodiment, the history of quality of acoustic communication is determined according to a plurality of measurements including at least one of signal level, noise level, SNR, BER, QoS, latency, jitter, frame loss, and call disconnect.

Further according to another exemplary embodiment, selecting the communication mode is determined according to at least one of position, direction of motion, and speed of motion.

Still further according to another exemplary embodiment, selecting the communication mode is determined according to location of the mobile device with respect to a communication quality map associated with the local node.

Yet further according to another exemplary embodiment, selecting the communication mode is determined according to at least one of: the mobile device is about to enter a cell of poor quality of acoustic communication, and the mobile device has exited a cell of poor quality of acoustic communication into a cell of good quality of acoustic communication into.

Even further according to another exemplary embodiment, the quality of acoustic communication is determined additionally according to current measurement of at least one of signal level, noise level, SNR, BER, QoS, latency, jitter, and frame loss.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified illustration of a hybrid communication system 10 combining acoustic and RF communication technologies;

FIG. 2 is a simplified block diagram of a computing system used by the a hybrid communication system; and

FIG. 3 includes three simplified flow charts for hybrid communication software program 21.

### DETAILED DESCRIPTION

The present embodiments comprise systems and methods for wireless communication, and more particularly to selection and/or roaming between radio-frequency (RF) wireless local area network (WLAN) technology and acoustic WLAN. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of embodiments described below is to provide at least one system and/or method for selection and/or roaming between acoustic wireless local area network (WLAN) technology and radio-frequency (RF) WLAN. However, the systems and/or methods as described herein may have other embodiments in similar technologies of capacitor-based loudspeakers.

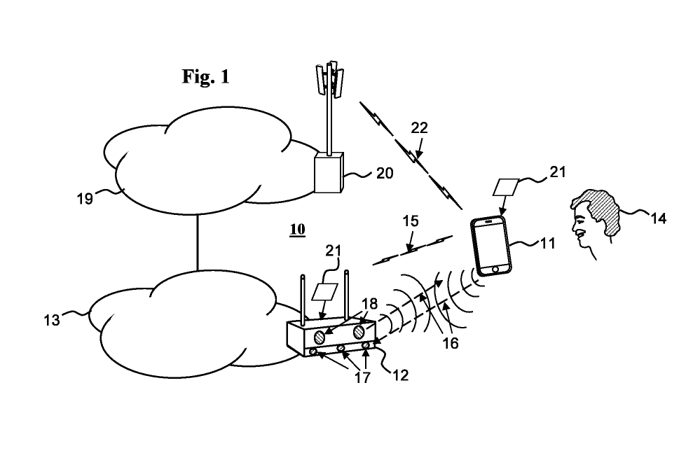

Reference is now made to FIG. 1, which is a simplified illustration of a hybrid communication system 10 combining acoustic and RF communication technologies, according to one exemplary embodiment.

As shown in FIG. 1, hybrid communication system 10 may include at least one hybrid mobile device 11 such as a mobile telephone device and/or a smartphone, and a hybrid local communication node 12, such as a router. The hybrid local communication node 12 may be typically communicatively coupled to a wide area network (WAN) 13, such as the Internet. Hybrid mobile device 11 may be typically operated by a user 14.

Hybrid mobile device 11 may be communicatively coupled to hybrid local communication node 12 via a radio-frequency (RF) communication technology 15 such as Wi-Fi and/or Bluetooth (respectively WLAN and WPAN), and via an acoustic communication technology 16.

The term ‘hybrid’ and/or ‘hybrid communication’ may refer to the ability of hybrid communication system 10 to switch between two or more different communication technologies and/or modes within a communication session without interruption to the communication. For example, the two communication technologies and/or modes may be RF communication and acoustic communication. It is appreciated that, for example, acoustic communication consumes less power than RF communication, however, acoustic communication may be limited by walls. It is therefore advantageous to have a communications system that can use such two or more communication technologies and switch between communication technologies instantaneously without affecting call quality.

Hybrid local communication node 12 may include at least one microphone 17 and at least one speaker 18 to provide the acoustic communication technology 16. Typically, hybrid local communication node 12 may include a plurality of microphones 17 and a plurality of speakers 18. Microphones 17 and speakers 18 are used by hybrid communication system 10 to provide acoustic communication. Microphones 17 and speakers 18 of hybrid mobile device 11 are note shown in FIG. 1. Hybrid local communication node 12 may also include a plurality of microphones 17 and a plurality of speakers 18 to improve signal quality and to provide acoustic triangulation.

Hybrid mobile device 11 may optionally be communicatively coupled to a wireless wide area network (WWAN) such as a cellular network 19, typically via a local base-station 20. Hybrid local communication node 12 may also be optionally communicatively coupled to a wireless wide area network (WWAN), such as a cellular network 19, typically via local base-station 20.

Hybrid mobile device 11 and/or hybrid local communication node 12 may also include hybrid communication software program 21. Hybrid communication software program 21 may enable hybrid mobile device 11 and/or hybrid local communication node 12 to determine and/or to select a communication mode, such as between RF communication technology 15 and acoustic communication technology 16, and optionally also cellular communication mode 22.

In one embodiment, hybrid communication software program 21 may select a wireless communication mode between the hybrid mobile device 11 and the hybrid local communication node 12. The mode selection is between RF communication mode and/or technology and acoustic communication mode and/or technology. Hybrid communication software program 21 may determine the selected mode by measuring the quality of the acoustic communication, and switching to RF communication if the quality of acoustic communication is below a predefined threshold. The quality of acoustic communication may be determined according to measurement one or more of: signal level, noise level, SNR, BER, QoS, latency, jitter, and frame loss. Particularly, hybrid communication software program 21 may switch from acoustic communication to RF communication when the signal level drops below a predefined threshold.

In another embodiment, the selection between the available communication modes is determined according to the location of the hybrid mobile device 11. Particularly, the communication modes is determined and/or selected according to the location of the hybrid mobile device 11 with respect to the hybrid local communication node 12. Therefore, hybrid communication software program 21 may be able to calculate the location of hybrid mobile device 11 with respect to the hybrid local communication node 12 in real-time.

Selecting a communication mode according to the location of hybrid mobile device 11, and particularly considering motion direction and/or speed of motion of hybrid mobile device 11, enables hybrid communication system 10 to select the appropriate communication technology before the signal quality drops.

For example, if hybrid communication system 10 (e.g., hybrid mobile device 11 or hybrid local communication node 12, or both) determines that hybrid local communication node 12 is about to enter a region (location) of poor communication quality then hybrid communication system 10 may switch to RF communication before hybrid mobile device 11 enters the poor quality region, and/or before the signal quality drops.

Hybrid local communication node 12 may determine the location of the hybrid mobile device 11 by acoustic signal triangulation. For example, hybrid mobile device 11 may transmit an acoustic pilot signal synchronized with an RF pilot signal. The hybrid local communication node 12 may determine the location of the hybrid mobile device 11, for example, by comparing the time of arrival of the acoustic pilot signal by two or more microphones 17. The difference between the time of arrival, considering the location of, or distance between, the two or more microphones 17, and the time of arrival of the RF signal, may be used to compute the location of the hybrid mobile device 11 with respect to the hybrid local communication node 12.

In a similar manner, hybrid mobile device 11 may also determine its location with respect to hybrid local communication node 12 by acoustic signal triangulation. For example, hybrid local communication node 12 may transmit two or more acoustic pilot signals synchronized with an RF pilot signal where each of the acoustic pilot signals is transmitted by a different speaker 18 of the hybrid local communication node 12. The hybrid mobile device 11 may determine its location, for example, by comparing the time of arrival of the acoustic pilot signal by two or more speakers 18, and the time of arrival of the RF signal. The different acoustic pilot signal may be differentiated by their different carrier frequency, or by a different modulation of the carrier frequency, or both.

It is appreciated that similarly hybrid mobile device 11 may also include a plurality of microphones and or speakers and use them for acoustic triangulation to measure the location of the hybrid mobile device 11 as described above.

It is appreciated that Doppler effect affecting the acoustic pilot signal may be used to measure motion direction and/or speed of motion of the hybrid mobile device 11 with respect to hybrid local communication node 12.

Additionally, hybrid communication software program 21 may be able to map locations of hybrid mobile device 11 with respect to the hybrid local communication node 12 in which acoustic communication is relatively ineffective, or where there is relatively high probability that the acoustic communication may become relatively ineffective.

The term ‘location’ may refer to position, direction of motion, and speed of motion of the hybrid mobile device 11 with respect to the hybrid local communication node 12.

The term ‘relatively ineffective’, or ‘poor quality’ may refer to the quality of the communication technology, such as decreased signal strength, decreased signal-to-noise ratio (SNR), increased bit-error-rate (BER), etc. If, for example, a particular location is repeatedly associated with low quality of service (QOS), weak signal, decreased SNR, increased BER, disconnections, etc. the location, or region, or area closely around the location, is associated with, or characterized by, ‘relatively ineffective’ or ‘poor quality’ acoustic communication. Other locations may be associated with, or characterized by, ‘relatively effective’ or ‘good quality’ acoustic communication.

It is appreciated that a locality may include a plurality of hybrid local communication nodes 12, and that a hybrid mobile device 11 may be used with more than one hybrid local communication node 12, and/or roam between hybrid local communication nodes 12. It is appreciated that the mapping process may be typically separate for each of the hybrid local communication nodes 12.

It is appreciated that the mapping process may be shared between hybrid mobile devices 11 used with the same hybrid local communication node 12 if the hybrid mobile devices 11 have the same communication characteristics and/or specifications. It is appreciated that, for example, two (or more) different hybrid local communication nodes 12 may have a different characterization (mapping) of a particular area covered by both hybrid local communication nodes 12.

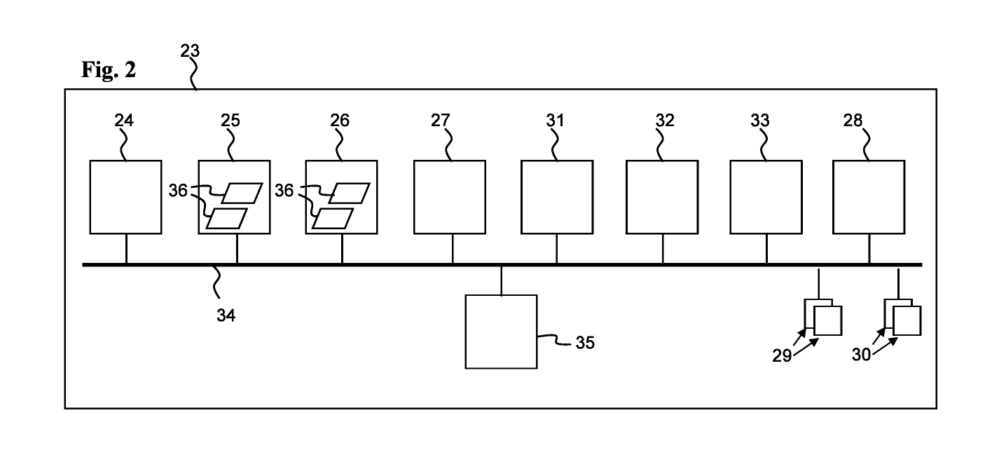

Reference is now made to FIG. 2, which is a simplified block diagram of a computing system 23, according to one exemplary embodiment. As an option, the block diagram of FIG. 2 may be viewed in the context of the details of the previous Figures. Of course, however, the block diagram of FIG. 2 may be viewed in the context of any desired environment. Further, the aforementioned definitions may equally apply to the description below.

The block diagram of computing system 23 may represent a general example of a hybrid mobile device 11, and/or a hybrid local communication node 12, and/or any other computing device that may be used for executing hybrid communication software program 21, or any part of hybrid communication software program 21, or any other type of software program.

The term ‘computing system’ or ‘computing device’ relates to any type or combination of computing devices, or computing-related units, including, but not limited to, a processing device, a memory device, a storage device, and/or a communication device.

As shown in FIG. 2, computing system 23 may include at least one processor unit 24, one or more memory units 25 (e.g., random access memory (RAM), a non-volatile memory such as a Flash memory, etc.), one or more storage units 26 (e.g. including a hard disk drive and/or a removable storage drive, representing a floppy disk drive, a magnetic tape drive, a compact disk drive, a flash memory device, etc.).

Computing system 23 may also include one or more communication sub-systems. Particularly, computing system 23 may include an RF communication sub-system 27 such as, for example, Wi-Fi and/or Bluetooth. Computing system 23 may include an acoustic communication sub-system 28 typically connected to one or more microphones 29, and one or more speakers 30. Computing system 23 may also include a cellular communication sub-system.

Computing system 23 may also include one or more graphic processors 31 and displays 32, a variety of user input and output (I/O) devices 33, and one or more communication buses 34 connecting the above units. Computing system 23 may be powered by a power supply 35, which may include a battery.

Computing system 23 may also include one or more computer programs 36, or computer control logic algorithms, which may be stored in any of the memory units 25 and/or storage units 26. Such computer programs, when executed, enable computing system 23 to perform various functions (e.g. as set forth in the context of FIG. 1, etc.). Memory units 25 and/or storage units 26 and/or any other storage are possible examples of tangible computer-readable media.

Particularly, computer programs 36 may include Hybrid communication software program 21.

The term ‘RF Communication’ may refer to any type of communication technologies such as short-range communication (e.g., PAN, such as USB, Wi-Fi, Bluetooth, etc.) or long-range communication (e.g., Ethernet, IP, Cellular, WiMAX, etc.), whether wired or wireless. For that matter, computing system 23 and/or communication units 27 may include a subscriber identity module (SIM) or a similar device.

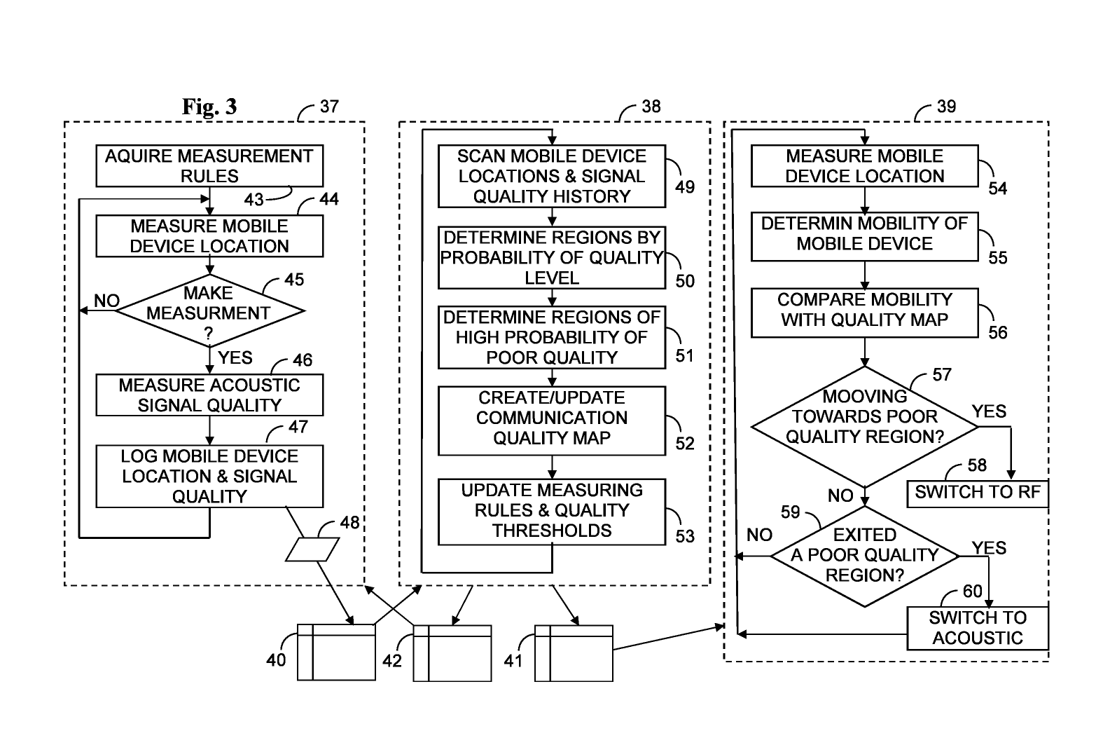

Reference is now made to FIG. 3, which includes three simplified flow charts for hybrid communication software program 21, according to one exemplary embodiment.

As an option, the flow charts of FIG. 3 may be viewed in the context of the details of the previous Figures. Of course, however, the flow charts of FIG. 3 may be viewed in the context of any desired environment. Further, the aforementioned definitions may equally apply to the description below.

As shown in FIG. 3, hybrid communication software program 21 may include three modules: a scanning module 37, a mapping module 38, and a mode selection module 39.

It is appreciated that hybrid communication software program 21 and any of its modules may be executed by hybrid mobile device 11, or by hybrid local communication node 12, or by both. A processor of hybrid mobile device 11 may execute any one of the modules of hybrid communication software program 21 and/or any combination of modules. A processor of hybrid local communication node 12 may execute any one of the modules of hybrid communication software program 21 and/or any combination of modules. Any module of hybrid communication software program 21 may be executed by hybrid mobile device 11, or by hybrid local communication node 12, or by both.

Typically, scanning module 37, mapping module 38, and a mode selection module 39 are processed in parallel, continuously or repeatedly, typically throughout the operation of hybrid communication system 10, or when hybrid mobile device 11 is being used by a user 14.

Scanning module 37 may measure the quality of the communication between hybrid mobile device 11 and hybrid local communication node 12 and may produce a database of quality measurements 40.

Mapping module 38 may analyze the data of the communication quality measurements of database 40 and produce a map 41 of cells (e.g., regions, areas) and their respective average communication quality levels. Mapping module 38 may also produce a set of communication quality measuring rules, thresholds and/or levels stored in rules database 42.

Mode selection module 39 may use map 41 to determine which communication mode (e.g., RF or acoustic) should be used by and/or between hybrid mobile device 11 and/or hybrid local communication node 12. Particularly, such decision may be made by mode selection module 39 when mode selection module 39 detects that hybrid local communication node 12 is about to enter a particular cell (of map 41) or has exited a particular cell.

As shown in FIG. 3, scanning module 37 may start with step 43 by acquiring communication quality measuring rules. Communication quality measuring rules, thresholds and/or levels may be set by a user, or downloaded via the Internet, and may be later updated continuously and/or repeatedly by mapping module 38. Communication quality measuring rules may instruct scanning module 37 when, where and how to measure the quality of acoustic communication between hybrid mobile device 11 and hybrid local communication node 12.

Scanning module 37 may proceed to step 44 to measure the current location, or position, of the hybrid mobile device 11 with respect to the particular hybrid local communication node 12. As hybrid mobile device 11 may roam between hybrid local communication nodes 12 the entire process of hybrid communication software program 21 is associated with a particular hybrid local communication nodes 12.

Scanning module 37 may proceed to step 45 to determine if a measurement should be performed, based on the measurement rule obtained. The measuring rule may indicate a location, or region, in which measurements should be carried, and/or time, or frequency (rate), in which measurements should be carried, or one or more conditions, such as crossing a threshold or a level, in which measurements should be stored, or combinations thereof. The measuring rule may also indicate measurements according to the direction and/or speed of motion of the hybrid mobile device 11 as may be indicated by an accelerometer or a similar motion detection devices in the hybrid mobile device 11. The measuring rule may also indicate one or more types of measurements to be carried, such as signal level, noise level, SNR, BER, QoS, latency, jitter, frame loss, etc..

A measurement is typically carried by sending or receiving or exchanging a pilot signal between the hybrid mobile device 11 and the hybrid local communication node 12. The measurement may record the one or more values of signal level (strength), noise level, SNR, BER, QoS, latency, jitter, frame loss, etc.

Scanning module 37 may proceed to step 46 to make the measurement, if required, and to step 47 to store the measurement result 48, with the location and time of measurement, to the measurements database 40.

Scanning module 37 may repeat the above steps continuously, or at a predetermined rate, according, for example, the relevant measuring rule. Scanning module 37 may execute measurements of acoustic communication when acoustic communication is selected and/or used, and also when RF communication is selected and/or used.

Mapping module 38, typically executed in parallel to scanning module 37, may start with step 49 by scanning the measurements database 40 and compute (create and update) a map of regions, or cells, and their respective level of quality of acoustic communication. As the number and density of the measurements grows, mapping module 38 may increase the resolution of the map. The resolution of the map may therefore change according to the availability (number) and density of the measurements. Areas with higher measurement density may be divided into smaller cells. If a particular cell shows a gradient, or a relatively large variance, of measurements, mapping module 38 may amend the measuring rule to have more measurements for that area.

Mapping module 38 may proceed to step 50 to determine the regions, or cells, for example, according to the probability of a particular level of communication quality. The level of communication quality may be computed according to a predetermined rule calculating communication quality value according to any combination of signal level (strength), noise level, SNR, BER, QoS, latency, jitter, frame loss, etc. From time to time the mapping module 38 may modify the rule.

Some regions, or cells, may have more than one quality levels. For example, a region close to a door or a window or a curtain may have a different value if the door or window or curtain is open or closed. Similarly a noisy instrument (e.g., a coffee machine) may affect the quality level when operated.

Mapping module 38 may proceed to step 51 to determine, or divide, or characterize, the regions as regions of good and poor communication quality. Hybrid mobile device 11 should not use acoustic communication in regions, or cells, of poor quality.

Mapping module 38 may proceed to step 52 to create, or update, quality map 41 and to step 53 to update one or more measuring rules, if needed, and/or one or more quality thresholds, if needed.

Mode selection module 39, typically executed in parallel to scanning module 37 and/or mapping module 38, may start with step 54 by measuring the location, motion direction, and speed of motion, of hybrid mobile device 11.

Mode selection module 38 may proceed to step 55 to determine the mobility of hybrid mobile device 11 in terms of the cell structure and/or topology of quality map 41, and to step 56 to evaluate the communication quality according to the quality map 41.

If mode selection module 38 determines that hybrid mobile device 11 is about to enter a region, or cell, indicated (by mapping module 38 in quality map 41) as having poor quality of acoustic communication (step 57) then mode selection module 38 may select to switch hybrid mobile device 11 from acoustic communication to RF communication (step 58).

If mode selection module 38 determines that hybrid mobile device 11 has exited a region, or cell, indicated (by mapping module 38 in quality map 41) as having poor quality of acoustic communication into a good quality cell (step 59), then mode selection module 38 may select to switch hybrid mobile device 11 from acoustic communication to RF communication (step 60).

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

1-27. (canceled)

28. A method for selecting wireless communication mode between a mobile device and a local node, wherein said selection is between RF communication technology and acoustic communication technology, the method comprising:
measuring quality of acoustic communication; and
switching to RF communication if said quality of acoustic communication is below a predefined threshold;
wherein said quality of acoustic communication is determined according to measurement of at least one of: signal level, noise level, SNR, BER, QoS, latency, jitter, and frame loss.

29. The method according to claim 28, additionally comprising:
determining location of said mobile device with respect to said local node; and
selecting said communication mode according to said location;
wherein said location is characterized according to history of quality of acoustic communication in said location.

30. The method according to claim 29, wherein said quality of acoustic communication is measured at least one of: continuously, repeatedly, when said selected communication mode is RF communication technology and when said selected communication mode is acoustic communication technology.

31. The method according to claim 29, wherein said history of quality of acoustic communication is determined according to a plurality of measurements comprising at least one of: signal level, noise level, SNR, BER, QoS, latency, jitter, frame loss, and call disconnect.

32. The method according to claim 29, wherein said selecting said communication mode is determined according to at least one of position, direction of motion, speed of motion, and location of said mobile device with respect to a communication quality map associated with said local node.

33. The method according to claim 29, wherein said selecting said communication mode is determined according to at least one of:
said mobile device is about to enter a cell of poor quality of acoustic communication; and
said mobile device has exited a cell of poor quality of acoustic communication into a cell of good quality of acoustic communication into.

34. The method according to claim 29, wherein said quality of acoustic communication is determined additionally according to current measurement of at least one of: signal level, noise level, SNR, BER, QoS, latency, jitter, and frame loss.

35. A communication system comprising:
an RF communication sub-system communicatively coupling a mobile device and a local node;
an acoustic communication sub-system communicatively coupling said mobile device and said local node; and
a communication quality assessment sub-system operative to determine quality of acoustic communication according to measurement of at least one of: signal level, noise level, SNR, BER, QoS, latency, jitter, and frame loss.
a communication mode selection sub-system configured to switch to RF communication sub-system when said quality of acoustic communication is below a predefined threshold.

36. The communication system according to claim 35, additionally comprising:
a location measuring sub-system; and
wherein said communication mode selection sub-system is operative to select between said RF communication sub-system and said acoustic communication sub-system according to said location measurement of said mobile device with respect to said local node;
wherein said location is characterized according to history of quality of usage of acoustic communication in said location.

37. The communication system according to claim 36, additionally comprising:
a communication quality measuring sub-system;
wherein said communication quality measuring sub-system measures said quality of acoustic communication at least one of: continuously, repeatedly, when said selected communication sub-system is RF communication sub-system, and when said selected communication sub-system is acoustic communication sub-system.

38. The communication system according to claim 37, wherein said communication quality measuring sub-system measures said quality of acoustic communication according to a plurality of measurements comprising at least one of: signal level, noise level, SNR, BER, QoS, latency, jitter, frame loss, and call disconnect.

39. The communication system according to claim 36, wherein said communication mode selection sub-system selects said communication mode according to at least one of position, direction of motion, speed of motion, and location of said mobile device with respect to a communication quality map associated with said local node.

40. The communication system according to claim 36, wherein said communication mode selection sub-system selects said communication mode according to at least one of: said mobile device is about to enter a cell of poor quality of acoustic communication; and said mobile device has exited a cell of poor quality of acoustic communication into a cell of good quality of acoustic communication into.

41. The communication system according to claim 37, wherein said communication quality measuring sub-system determines said quality of acoustic communication additionally according to a current measurement of at least one of: signal level, noise level, SNR, BER, QoS, latency, jitter, and frame loss.

42. A computer program product embodied on a non-transitory computer readable medium, including instructions that, when executed by at least one processor, cause the processor to perform operations comprising:
measuring quality of acoustic communication; and
switching to RF communication if said quality of acoustic communication is below a predefined threshold;
wherein said quality of acoustic communication is determined according to measurement of at least one of: signal level, noise level, SNR, BER, QoS, latency, jitter, and frame loss.

43. The computer program according to claim 42, additionally comprising:
determining location of said mobile device with respect to said local node; and
selecting a communication mode according to characterization of said location, said communication mode comprising one of: RF communication and acoustic communication;
wherein said location is characterized according to history of quality of acoustic communication in said location.

44. The computer program according to claim 43, wherein said quality of acoustic communication is measured at least one of: continuously, repeatedly, when said selected communication mode is RF communication technology, and when said selected communication mode is acoustic communication technology.

45. The computer program according to claim 43, wherein said history of quality of acoustic communication is determined according to a plurality of measurements comprising at least one of: signal level, noise level, SNR, BER, QoS, latency, jitter, frame loss, and call disconnect.

46. The computer program according to claim 43, wherein said selecting said communication mode is determined according to at least one of position, direction of motion, speed of motion, location of said mobile device with respect to a communication quality map associated with said local node, when said mobile device is about to enter a cell of poor quality of acoustic communication, and when said mobile device has exited a cell of poor quality of acoustic communication into a cell of good quality of acoustic communication into.

47. The computer program according to claim 43, wherein said quality of acoustic communication is determined additionally according to current measurement of at least one of: signal level, noise level, SNR, BER, QoS, latency, jitter, and frame loss.
